(19) United States
(12) Patent Application Publication
(10) Pub. No.: US 2021/0336464 A1
(43) Pub. Date: Oct. 28, 2021

(54) INFERENCE BASED FAST CHARGING

(71) Applicant: Intel Corporation, Santa Clara, CA (US)

(72) Inventors: Brian C. Fritz, Milpitas, CA (US); Taylor Moore, Hillsboro, OR (US); Naoki Matsumura, San Jose, CA (US)

(73) Assignee: Intel Corporation, Santa Clara, CA (US)

(21) Appl. No.: 16/860,927

(22) Filed: Apr. 28, 2020

(51) Int. Cl. H02J 7/00

(52) U.S. Cl. CPC H02J 7/0071; H02J 7/0048

(57) ABSTRACT

A scheme to initiate fast charging of a battery based on inference, situation, and/or need. The scheme uses a situational fast charging algorithm that detects user's situation and judges if fast battery charging is needed and enables fast charging. Once the need for fast charging need is detected, there are at least two options to follow. In the first option, when a charger cannot provide enough power to support both system and battery fast charging, the system turns down system power (e.g., reduces display brightness) and starts fast charging with available charger power to a sufficient charge level. In the second option, when a charger can provide enough power to support both system and battery fast charging, the system starts fast charging to a sufficient charge level.

### BACKGROUND

Most mobile computing systems have a rechargeable battery (e.g. Li-ion battery) and a charger (e.g. AC adapter, Universal Serial Bus (USB) charger). When a plugged-in system is powered on and the attached battery is charged, a charger needs to supply current/power to both the system and battery. In some situations, end users need fast battery charging. For example, if a user is at an airport terminal and is about to get on an airplane where there may not be an outlet, the user may want to charge the battery as fast as possible before getting on the airplane. To do this, higher current/power needs to be supplied from a charger to the battery if the system and/or battery supports fast battery charging.

For fast charging, users usually have to buy and bring a more powerful but larger and/or heavier charger at extra cost. This is because if a charger does not have sufficient power to support both system power and charging, battery charging may be deprioritized. Additional cost for a charger is not preferable to users. Also, when a powerful charger is always performing fast charging when fast charging is not needed, such fast charging may accelerate battery degradation and decrease longevity of the battery.

A user may want to fast charge a battery with an existing less-powerful charger. In this case, a user may manually turn off or turn down system power consumption to allocate more power for battery charging. Turning down system power consumption includes lowering CPU (central processing unit) performance and/or lowering display brightness. However, such manual change of setting is cumbersome.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a device having a battery and logic for inference based fast charging, in accordance with some embodiments.

FIG. 2 illustrates a flowchart of a method for inference based fast charging, in accordance with some embodiments.

FIG. 3 illustrates a graphical user interface (GUI) for modifying inference based fast charging, in accordance with some embodiments.

FIG. 4 illustrates a smart device or a computer system or an SoC (System-on-Chip) powered by a battery which is capable of inference based fast charging, in accordance with some embodiments.

### DETAILED DESCRIPTION

Some embodiments provide a method to initiate fast charging of a battery based on inference, situation, and/or need. In some embodiments, the method uses a situational fast charging algorithm that detects user's situation and judges if fast battery charging is needed and enables fast charging. Once the need for fast charging need is detected, there are at least two options to follow. In the first option, when a charger cannot provide enough power to support both system and battery fast charging, the system turns down system power (e.g., reduces display brightness) and starts fast charging with available charger power to a sufficient charge level. In the second option, when a charger can provide enough power to support both system and battery fast charging, the system starts fast charging to a sufficient charge level. As the method of various embodiments turns on fast charging on a as-needed basis, it mitigates battery degradation caused by fast charging and/or it enables fast charging without a more expensive charger by turning down system power. Other technical effects will be evident from the various embodiments and figures.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “adjacent” here generally refers to a position of a thing being next to (e.g., immediately next to or close to with one or more things between them) or adjoining another thing (e.g., abutting it).

The term “circuit” or “module” may refer to one or more passive and/or active components that are arranged to cooperate with one another to provide a desired function.

The term “signal” may refer to at least one current signal, voltage signal, magnetic signal, or data/clock signal. The meaning of “a,” “an,” and “the” include plural references. The meaning of “in” includes “in” and “on.”

The term “analog signal” here generally refers to any continuous signal for which the time varying feature (variable) of the signal is a representation of some other time varying quantity, i.e., analogous to another time varying signal.

The term “digital signal” is a physical signal that is a representation of a sequence of discrete values (a quantified discrete-time signal), for example of an arbitrary bit stream, or of a digitized (sampled and analog-to-digital converted) analog signal.

The term “scaling” generally refers to converting a design (schematic and layout) from one process technology to another process technology and may be subsequently being reduced in layout area. In some cases, scaling also refers to upsizing a design from one process technology to another process technology and may be subsequently increasing layout area. The term “scaling” generally also refers to downsizing or upsizing layout and devices within the same technology node. The term “scaling” may also refer to adjusting (e.g., slowing down or speeding up—i.e. scaling down, or scaling up respectively) of a signal frequency relative to another parameter, for example, power supply level. The terms “substantially,” “close,” “approximately,” “near,” and “about,” generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions.

It is pointed out that those elements of the figures having the same reference numbers (or names) as the elements of any other figure can operate or function in any manner similar to that described but are not limited to such.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors (BJT PNP/NPN), BiCMOS, CMOS, etc., may be used without departing from the scope of the disclosure.

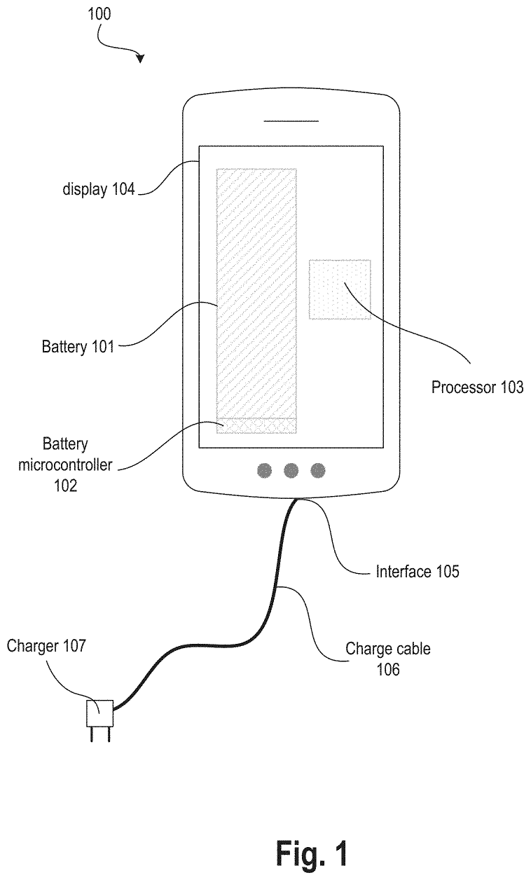

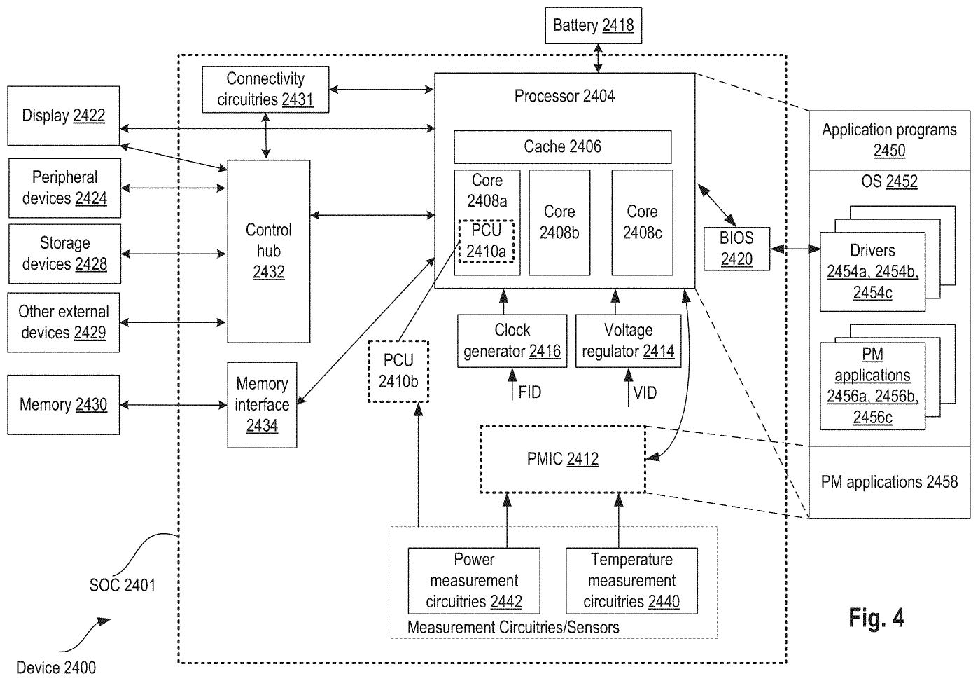

FIG. 1 illustrates device 100 having a battery and logic for inference based fast charging, in accordance with some embodiments. In some embodiments, device 100 comprises battery 101, battery microcontroller 102, processor 103, display 104, and interface 105 for charging cable 106. Charging cable 106 is coupled to charger 107 which is capable of providing fast charge to battery 101. In some embodiments, battery 101 and battery microcontroller 102 are part of a battery unit, where battery 101 comprises a number of battery cells connected together. In some embodiments, battery 101 uses Li-Ion technology. In some embodiments, microcontroller 102 includes a fuel gauge and logic for inference based fast charging. In some embodiments, processor 103 is a system-on-chip as described with reference to FIG. 4. In some embodiments, device 101 includes a display 2422 as described with reference to FIG. 4.

Referring back to FIG. 1, device 100 includes interface 105 which can be connected to a charging cable 106. Charging cable 106 can be a universal serial bus compliant cable or any other suitable cable. Charging cable 106 is connected to charger 107, which is capable of supplying charge.

Here, the term “fast charging” generally refers to charging a battery pack (one or more battery cells) at greater than or equal to 0.5 c. Fast charging may raise the voltage and/or provide higher amount of current than/for the battery pack. For example, fast charging may increase voltage up to 5 V, 9 V, 12 V, and higher such that amperage increases to 3 Amperes or more. Here, the term “normal” charging generally refers to charging a battery pack at less than 0.5 c. In some embodiments, fast charging may be constant current charging, constant voltage charging, pulse charging and/or combination of these charging schemes.

In some embodiments, a logic of device 100 such as microcontroller 102 and/or processor 103 applies a situational or inference based fast charging algorithm that detects user's situation and judges if fast battery charging is needed, and if so, enables fast charging. To detect if user is in a situation which needs fast charging, microcontroller 102 and/or processor 103 analyzes one or more parameters. For example, microcontroller 102 and/or processor 103 analyzes user's location (e.g. station, airport, cruise ship, coffee shop, restaurant, gas station, campground, etc.) to determine whether fast charging is needed. The one or more parameters may also include user's near-future schedule (e.g., travel, departure, meeting, any events that need battery power, etc.). Microcontroller 102 and/or processor 103 may also analyze user's usage model (e.g., requirement of Wi-Fi/modem, requirement of numbers of processor cores, workload, type of applications being run, etc.) and remaining battery capacity.

For example, if user is at an airport (location) working on documents on a laptop with internet connection and is about to depart soon, such as in 30 minutes, (near-future schedule) but battery fuel gauge shows 10% (remaining battery capacity), then microcontroller 102 and/or processor 103 detects that and concludes that the user needs fast charging. Once the need for fast charging is detected, microcontroller 102 and/or processor 103 determines whether charger 107 can provide enough power to support both system and battery fast charging. If charger 107 cannot sustain fast charging to support both the system and battery fast charging, microcontroller 102 and/or processor 103 turns down system power (e.g. reduce display brightness) and starts fast charging with available charger power to a sufficient charge level (e.g., 60%). In some embodiments, when microcontroller 102 and/or processor 103 determines that charger 107 can provide enough power to support both system and battery fast charging, system starts fast charging to a sufficient charge level. By turning on fast charging when needed, microcontroller 102 and/or processor 103 mitigates battery degradation caused by fast charging or it enables fast charging without a more expensive charger by turning down system power.

When microcontroller 102 and/or processor 103 detects that fast charging is needed, it may ask for user's permission to start fast charging or turn down system power and start fast battery charging with available power. In some embodiments, when microcontroller 102 and/or processor 103 determines that charger 107 is not powerful enough to support both system and fast charging, system power that is turned down/off for fast charging may be, but is not limited to, display brightness, CPU performance, Wi-Fi, peripheral sensors, etc. For example, charger 107 is not powerful enough to support both system and fast charging may lower display brightness, reduce CPU performance, turn off Wi-Fi, disable peripheral sensors, etc.

In some embodiments, microcontroller 102 and/or processor 103 may cause fast charging to continue until battery 101 becomes full or battery 101 has sufficient charge level for the next situation/schedule. While the embodiments here are illustrated with reference to a mobile device, the embodiments are also applicable to datacenter batteries, backup batteries in offices/homes, batteries in consumer devices and tools, etc. Datacenter may use supplemental power from a backup battery and enables peak power mode for better performance After the peak power event, battery is recharged. When datacenter battery is in a situation where fast charging is needed, system starts fast battery charging to prepare for the next peak power event. In this case, the situation where backup battery may need to be fast charged may be, but is not limited to, future schedule (e.g., peak power schedule), usage model (e.g., frequency of peak power mode), battery charging level (e.g., fast charging may be needed when the previous peak power mode or other events used more energy than estimated), scheduled power outage, weather forecast (e.g. thunderstorm may cause power outage).

In some embodiments, microcontroller 102 and/or processor 103 may consider the time length to the situation and/or the time length of the situation, and then calculate the required charge level for the situation. Microcontroller 102 and/or processor 103 may also calculate the charge possible by the time length to the situation. The two calculations are then compared to determine if fast charging is needed. In some embodiments, microcontroller 102 and/or processor 103 may adjust the speed of fast charging to lower than a maximum fast charging speed if available time to the situation is sufficient to charge the battery to the required charge level. By adjusting charging speed from the maximum fast charging speed, microcontroller 102 and/or processor 103 reduces unnecessary system power adjustment and/or battery degradation.

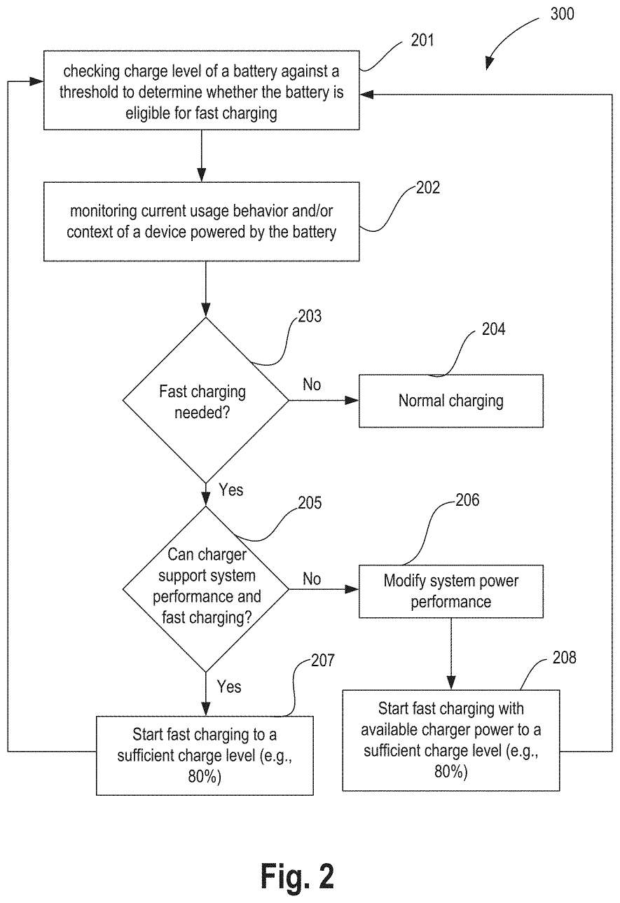

FIG. 2 illustrates flowchart 200 of a method for inference based fast charging, in accordance with some embodiments. While various blocks are illustrated in a particular order, the order can be modified. For example, some blocks are performed before others and some are performed simultaneously. In some embodiments, some of the blocks are performed by hardware (e.g., sensors that measure or check battery charge level), and some are performed by software or firmware. In some embodiments, all blocks are performed by software or firmware, such as firmware in a fuel gauge, operating system (OS), etc.

At block 201, a charge level of battery 101 is checked against a threshold level. For example, fuel gauge associated with battery 101 checks the charge level and provides that information to microcontroller 102 and/or processor 103. Fuel gauge may be part of microcontroller 102. The threshold can be predetermined (e.g., 10%) or a programmable level (e.g., programmable by software (OS) or hardware). Generally, the threshold is a low charge level (e.g., less than 30%) to establish when to flag or indicate that fast charging can be used.

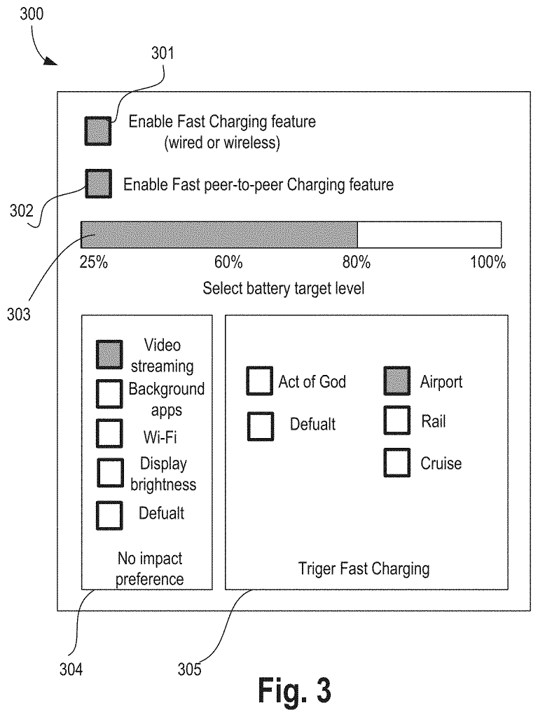

At block 202, microcontroller 102 and/or processor 103 monitors current usage behavior and or context of device 100. For example, microcontroller 102 and/or processor 103 checks with the OS to determine what applications are currently executing on processor 103, and whether any of those applications are deemed important by the user, as discussed with reference to FIG. 3. In some embodiments, context of device 100 refers to location of the device, schedule of the device, application executing by the device, and/or application displayed on a screen of the device. For example, if user is at a hotel (location) working on documents on a computer with internet connection and is about to checkout soon (near-future schedule) but battery fuel gauge shows 15% (remaining battery capacity), then microcontroller 102 and/or processor 103 detects that and concludes that the user needs fast charging as indicated by block 203. In another example, microcontroller 102 and/or processor 103 checks the calendar of the user and determines that the user is about to join a meeting soon and but battery fuel gauge shows 10% (remaining battery capacity), then microcontroller 102 and/or processor 103 detects that and concludes that the user needs fast charging as indicated by block 203 so his/her device is available for use if needed during the meeting. In some embodiments, microcontroller 102 and/or processor 103 applies machine-learning (ML) or artificial intelligence (AI) techniques to learn habits and routines of the user, and opportunistically determine that fast charging is needed as indicated by block 203.

If microcontroller 102 and/or processor 103 determines that fast charging is not needed then the process proceeds to block 204 where normal charging takes place. For example, the user has a charger hooked up to device 100, and microcontroller 102 and/or processor 103 determines from user habits and/or calendar that the user does not plan to use the device for any important task (as discussed with reference to FIG. 3) and or does not plan to leave the current location for a while (e.g., an hour or so), then microcontroller 102 and/or processor 103 decides to continue with normal charging instead of fast charging. Here, fast charging is greater or equal to 0.5 C, and normal charging is less than 0.5 C.

When microcontroller 102 and/or processor 103 determines that fast charging is desired and/or needed, the process proceeds to block 205 to determine whether charger 107 can indeed support device 100 (or computing system operating on the batter) to continue with its performance level and fast charge too (e.g., concurrently). If charger 107 can only provide excess charge (e.g., current and voltage) which is sufficient for system to operate at its current performance level, then microcontroller 102 and/or processor 103 begin a process of trade-offs as illustrated in block 206.

For example, microcontroller 102 and/or processor 103 modifies one or more parameters of device 100 to enable fast charging. The one or more parameters include: connection of Wi-Fi radio to an access point (AP); execution of a background application; display intensity; operating clock frequency, enabling or disabling one or more sensors, and automatic downloading of emails and/or attachments. The process then proceeds to block 208 where charger 107 is instructed by microcontroller 102 and/or processor 103 to begin fast charging batter 101 with available charger power to sufficiently charge battery 101 as indicated by desired level illustrated in FIG. 3.

Referring back to FIG. 2, if it is determined that charger 107 can support system performance which fast charging, then the process proceeds to block 207 where charger 107 is instructed by microcontroller 102 and/or processor 103 to begin fast charging battery 101 to sufficiently charge battery 101 as indicated by desired level illustrated in FIG. 3.

In some embodiments, microcontroller 102 and/or processor 103 may consider the time duration to the situation and/or the time duration of the situation, calculate the required charge level for the situation, calculate the charge possible for the time duration to the situation, compare both, and do fast charging if needed. In one example, the monitored current usage behavior and/or context of the device includes time duration to a situation and/or time duration of the situation. In that case, microcontroller 102 and/or processor 103 calculates or estimates a required charge level of the battery for the situation, and also calculates or estimates a charge possible for the battery for the time duration. Microcontroller 102 and/or processor 103 then compares the calculated required charge level and the charge possible, and determines if fast charging is needed based on the comparing. In some embodiments, microcontroller 102 and/or processor 103 determines a charge profile based on the calculating of the required charge level and the possible charge for the battery. The charge profile provides a signature of charging habits of the user. The charge profile can be used to train a model via machine-learning.

In some embodiments, microcontroller 102 and/or processor 103 may adjust the speed of fast charging for blocks 207 and/or 208 to lower than a maximum fast charging speed if available time to the situation is sufficient to charge the battery to the required charge level. By adjusting charging speed from the maximum fast charging speed, microcontroller 102 and/or processor 103 reduces unnecessary system power adjustment and/or battery degradation. In some embodiments, the method may proceeds from blocks 207 and/or 208 to block 201, and the process continues again.

In some embodiments, prior to modifying the one or more parameters, microcontroller 102 and/or processor 103 request permission from a user to modify the one or more system parameters. For example, a user is watching a movie on a Netflix® application and may not want to disrupt it for fast charging when charger 107 cannot support system performance and fast charging concurrently. In that case, the user may authorize microcontroller 102 and/or processor 103 to pause or kill background applications so that charger 107 can charge battery 101 to a sufficient level (e.g., 80%) while allowing the user to enjoy the movie.

In some embodiments, microcontroller 102 and/or processor 103 requests permission from a user to start fast charging of battery 101. For example, a pop-up notification shows up on the device's display 104 asking user whether it is ok to proceed with fast charging as it may interrupt or slow other activities of the system. In some embodiments, the notification is bypassed, and fast charging is performed automatically. For example, microcontroller 102 and/or processor 103 execute automatic fast charging before a scheduled power outage or any other act of God. In some embodiments, microcontroller 102 and/or processor 103 senses of an imminent natural event including: earthquake, tornado, flood, and thunderstorm. For example, microcontroller 102 and/or processor 103 accesses information from a news application, weather application, or any other suitable application to determine that an imminent natural event is about to occur and so it performs fast charging.

In some embodiments, prior to modifying the one or more parameters, microcontroller 102 and/or processor 103 provides a selection menu comprising the one or more system parameters for a user to select as illustrated in FIG. 3.

FIG. 3 illustrates graphical user interface (GUI) 300 for modifying inference based fast charging, in accordance with some embodiments. GUI 300 may be part of an application that is installed by an original equipment manufacturer (OEM), downloadable application, and/or part of an operating system. The application provides a user access to many parameters to set for fast charging. These parameters can be enabled or disabled. Radio button is used to enable or disable fast charging feature. In this example, the radio button 301 is enabled. While fast charging is described with reference to charge cable 106 and charger 107, it can also be performed via wireless means such as a wireless mat or inductive coupling. Radio button 302 is used to enable or disable fast peer-to-peer charging feature. For example, a user of a device may charge battery 101 using charge from another nearby device which also has fast peer-to-peer charging enabled. In some embodiments fast charging can be implemented by charge from charger 107 and peer-to-peer charging when charger 107 and/or peer-to-peer charging alone are not enough to fast charge and support system perform. Charge level bar 303 indicates the desired charge level for fast charging. In this example, the desired level is set to 80%.

Selection menu 304 lists a number of choices that a user can select as preference when microcontroller 102 and/or processor 103 executes block 206. In this example, video streaming is selected which means that the user allows microcontroller 102 and/or processor 103 to modify (e.g., pause or kill) background applications, turn off Wi-Fi, dim down brightness of display 104, and other actions while keeping video streaming uninterrupted. In some embodiments, a default option is available with preselected options based on user habits derived via machine-learning.

Selection menu 305 lists a number of choices that a user can select as preference when microcontroller 102 and/or processor 103 executes 207/208. In this example, airport is selected which means that the user allows microcontroller 102 and/or processor 103 to fast charge at any airport. Other selections available in this example are Rail, Cruise, Act of God. This list is a non-exhaustive list, and additional conditions can be added or removed. In some embodiments, a default option is available with preselected options based on user habits derived via machine-learning.

In some embodiments, microcontroller 102 and/or processor 103 may consider one or more of user's preferred parameters inferred from any previous manual selections and/or machine-learning from user's behavior and/or precedent, and adjusts non-preferred parameters to allocate more charging power. In some embodiments, microcontroller 102 and/or processor 103 may consider user permission to execute, one or more applications, as inferred by machine-learning to determine user's preferred parameters. Non-preferred parameters depend on the current usage of the device. For example, if the user is watching a movie on Netflix, diming the screen would be a non-preferred parameter, and other power saving techniques such as halting background applications may be used. Consideration of such parameters may happen automatically. For example, consideration of the preferred parameters may happen without prompting the user to avoid unnecessary disruption to the user.

Elements of embodiments (e.g., flowchart 200 and scheme described with reference to FIGS. 1-3) are also provided as a machine-readable medium (e.g., memory) for storing the computer-executable instructions (e.g., instructions to implement any other processes discussed herein). In some embodiments, a computing platform comprises a memory, a processor, a machine-readable storage media (also referred to as tangible machine readable medium), a communication interface (e.g., wireless or wired interface), and a network bus coupling them.

In some embodiments, the processor is a Digital Signal Processor (DSP), an Application Specific Integrated Circuit (ASIC), a general purpose Central Processing Unit (CPU), or a low power logic implementing a simple finite state machine to perform the method of flowchart 200 and/or various embodiments, etc.

In some embodiments, the various logic blocks of the system are coupled together via the network bus. Any suitable protocol may be used to implement the network bus. In some embodiments, the machine-readable storage medium includes instructions (also referred to as the program software code/instructions) for intelligent prediction of processor idle time as described with reference to the various embodiments and flowchart.

Program software code/instructions associated with flowchart 200 (and/or various embodiments) and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart 200 (and/or various embodiments) are executed by the computer system.

In some embodiments, the program software code/instructions associated with flowchart 200 (and/or various embodiments) are stored in a computer executable storage medium and executed by the processor. Here, computer executable storage medium is a tangible machine readable medium that can be used to store program software code/instructions and data that, when executed by a computing device, causes one or more processors to perform a method(s) as may be recited in one or more accompanying claims directed to the disclosed subject matter.

The tangible machine readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions (associated with flowchart 200 and other embodiments) and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media include but are not limited to recordable and non-recordable type media such as volatile and non-volatile memory devices, read only memory (ROM), random access memory (RAM), flash memory devices, magnetic random access memory, ferroelectric memory, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, the tangible machine readable medium includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

FIG. 4 illustrates a smart device or a computer system or a SoC (System-on-Chip) powered by a battery which is capable inference based fast charging, in accordance with some embodiments. It is pointed out that those elements of FIG. 4 having the same reference numbers (or names) as the elements of any other figure can operate or function in any manner similar to that described, but are not limited to such. Any of the blocks described here can have the inference based fast charging apparatus.

In some embodiments, device 2400 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 2400.

In an example, the device 2400 comprises a SoC (System-on-Chip) 2401. An example boundary of the SOC 2401 is illustrated using dotted lines in FIG. 4, with some example components being illustrated to be included within SOC 2401—however, SOC 2401 may include any appropriate components of device 2400.

In some embodiments, device 2400 includes processor 2404. Processor 2404 can include one or more physical devices, such as microprocessors, application processors, microcontrollers, programmable logic devices, processing cores, or other processing means. The processing operations performed by processor 2404 include the execution of an operating platform or operating system on which applications and/or device functions are executed. The processing operations include operations related to I/O (input/output) with a human user or with other devices, operations related to power management, operations related to connecting computing device 2400 to another device, and/or the like. The processing operations may also include operations related to audio I/O and/or display I/O.

In some embodiments, processor 2404 includes multiple processing cores (also referred to as cores) 2408a, 2408b, 2408c. Although merely three cores 2408a, 2408b, 2408c are illustrated in FIG. 4, processor 2404 may include any other appropriate number of processing cores, e.g., tens, or even hundreds of processing cores. Processor cores 2408a, 2408b, 2408c may be implemented on a single integrated circuit (IC) chip. Moreover, the chip may include one or more shared and/or private caches, buses or interconnections, graphics and/or memory controllers, or other components.

In some embodiments, processor 2404 includes cache 2406. In an example, sections of cache 2406 may be dedicated to individual cores 2408 (e.g., a first section of cache 2406 dedicated to core 2408a, a second section of cache 2406 dedicated to core 2408b, and so on). In an example, one or more sections of cache 2406 may be shared among two or more of cores 2408. Cache 2406 may be split in different levels, e.g., level 1 (L1) cache, level 2 (L2) cache, level 3 (L3) cache, etc.

In some embodiments, processor core 2404 may include a fetch unit to fetch instructions (including instructions with conditional branches) for execution by the core 2404. The instructions may be fetched from any storage devices such as the memory 2430. Processor core 2404 may also include a decode unit to decode the fetched instruction. For example, the decode unit may decode the fetched instruction into a plurality of micro-operations. Processor core 2404 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 2404 may be an out-of-order processor core in one embodiment. Processor core 2404 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 2404 may also include a bus unit to enable communication between components of processor core 2404 and other components via one or more buses. Processor core 2404 may also include one or more registers to store data accessed by various components of the core 2404 (such as values related to assigned app priorities and/or sub-system states (modes) association.

In some embodiments, device 2400 comprises connectivity circuitries 2431. For example, connectivity circuitries 2431 includes hardware devices (e.g., wireless and/or wired connectors and communication hardware) and/or software components (e.g., drivers, protocol stacks), e.g., to enable device 2400 to communicate with external devices. Device 2400 may be separate from the external devices, such as other computing devices, wireless access points or base stations, etc.

In an example, connectivity circuitries 2431 may include multiple different types of connectivity. To generalize, the connectivity circuitries 2431 may include cellular connectivity circuitries, wireless connectivity circuitries, etc. Cellular connectivity circuitries of connectivity circuitries 2431 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 2431 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 2431 may include a network interface, such as a wired or wireless interface, e.g., so that a system embodiment may be incorporated into a wireless device, for example, a cell phone or personal digital assistant.

In some embodiments, device 2400 comprises control hub 2432, which represents hardware devices and/or software components related to interaction with one or more I/O devices. For example, processor 2404 may communicate with one or more of display 2422, one or more peripheral devices 2424, storage devices 2428, one or more other external devices 2429, etc., via control hub 2432. Control hub 2432 may be a chipset, a Platform Control Hub (PCH), and/or the like.

For example, control hub 2432 illustrates one or more connection points for additional devices that connect to device 2400, e.g., through which a user might interact with the system. For example, devices (e.g., devices 2429) that can be attached to device 2400 include microphone devices, speaker or stereo systems, audio devices, video systems or other display devices, keyboard or keypad devices, or other I/O devices for use with specific applications such as card readers or other devices.

As mentioned above, control hub 2432 can interact with audio devices, display 2422, etc. For example, input through a microphone or other audio device can provide input or commands for one or more applications or functions of device 2400. Additionally, audio output can be provided instead of, or in addition to display output. In another example, if display 2422 includes a touch screen, display 2422 also acts as an input device, which can be at least partially managed by control hub 2432. There can also be additional buttons or switches on computing device 2400 to provide I/O functions managed by control hub 2432. In one embodiment, control hub 2432 manages devices such as accelerometers, cameras, light sensors or other environmental sensors, or other hardware that can be included in device 2400. The input can be part of direct user interaction, as well as providing environmental input to the system to influence its operations (such as filtering for noise, adjusting displays for brightness detection, applying a flash for a camera, or other features).

In some embodiments, control hub 2432 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 2422 represents hardware (e.g., display devices) and software (e.g., drivers) components that provide a visual and/or tactile display for a user to interact with device 2400. Display 2422 may include a display interface, a display screen, and/or hardware device used to provide a display to a user. In some embodiments, display 2422 includes a touch screen (or touch pad) device that provides both output and input to a user. In an example, display 2422 may communicate directly with the processor 2404. Display 2422 can be one or more of an internal display device, as in a mobile electronic device or a laptop device or an external display device attached via a display interface (e.g., DisplayPort, etc.). In one embodiment display 2422 can be a head mounted display (HMD) such as a stereoscopic display device for use in virtual reality (VR) applications or augmented reality (AR) applications.

In some embodiments, and although not illustrated in the figure, in addition to (or instead of) processor 2404, device 2400 may include Graphics Processing Unit (GPU) comprising one or more graphics processing cores, which may control one or more aspects of displaying contents on display 2422.

Control hub 2432 (or platform controller hub) may include hardware interfaces and connectors, as well as software components (e.g., drivers, protocol stacks) to make peripheral connections, e.g., to peripheral devices 2424.

It will be understood that device 2400 could both be a peripheral device to other computing devices, as well as have peripheral devices connected to it. Device 2400 may have a “docking” connector to connect to other computing devices for purposes such as managing (e.g., downloading and/or uploading, changing, synchronizing) content on device 2400. Additionally, a docking connector can allow device 2400 to connect to certain peripherals that allow computing device 2400 to control content output, for example, to audiovisual or other systems.

In addition to a proprietary docking connector or other proprietary connection hardware, device 2400 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 2431 may be coupled to control hub 2432, e.g., in addition to, or instead of, being coupled directly to the processor 2404. In some embodiments, display 2422 may be coupled to control hub 2432, e.g., in addition to, or instead of, being coupled directly to processor 2404.

In some embodiments, device 2400 comprises memory 2430 coupled to processor 2404 via memory interface 2434. Memory 2430 includes memory devices for storing information in device 2400.

In some embodiments, memory 2430 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 2430 can be a dynamic random access memory (DRAM) device, a static random access memory (SRAM) device, flash memory device, phase-change memory device, or some other memory device having suitable performance to serve as process memory. In one embodiment, memory 2430 can operate as system memory for device 2400, to store data and instructions for use when the one or more processors 2404 executes an application or process. Memory 2430 can store application data, user data, music, photos, documents, or other data, as well as system data (whether long-term or temporary) related to the execution of the applications and functions of device 2400.

Elements of various embodiments and examples are also provided as a machine-readable medium (e.g., memory 2430) for storing the computer-executable instructions (e.g., instructions to implement any other processes discussed herein). The machine-readable medium (e.g., memory 2430) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 2400 comprises temperature measurement circuitries 2440, e.g., for measuring temperature of various components of device 2400. In an example, temperature measurement circuitries 2440 may be embedded, or coupled or attached to various components, whose temperature are to be measured and monitored. For example, temperature measurement circuitries 2440 may measure temperature of (or within) one or more of cores 2408a, 2408b, 2408c, voltage regulator 2414, memory 2430, a mother-board of SOC 2401, and/or any appropriate component of device 2400.

In some embodiments, device 2400 comprises power measurement circuitries 2442, e.g., for measuring power consumed by one or more components of the device 2400. In an example, in addition to, or instead of, measuring power, the power measurement circuitries 2442 may measure voltage and/or current. In an example, the power measurement circuitries 2442 may be embedded, or coupled or attached to various components, whose power, voltage, and/or current consumption are to be measured and monitored. For example, power measurement circuitries 2442 may measure power, current and/or voltage supplied by one or more voltage regulators 2414, power supplied to SOC 2401, power supplied to device 2400, power consumed by processor 2404 (or any other component) of device 2400, etc.

In some embodiments, device 2400 comprises one or more voltage regulator circuitries, generally referred to as voltage regulator (VR) 2414. VR 2414 generates signals at appropriate voltage levels, which may be supplied to operate any appropriate components of the device 2400. Merely as an example, VR 2414 is illustrated to be supplying signals to processor 2404 of device 2400. In some embodiments, VR 2414 receives one or more Voltage Identification (VID) signals, and generates the voltage signal at an appropriate level, based on the VID signals. Various type of VRs may be utilized for the VR 2414. For example, VR 2414 may include a “buck” VR, “boost” VR, a combination of buck and boost VRs, low dropout (LDO) regulators, switching DC-DC regulators, constant-on-time controller based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 2410a/b and/or PMIC 2412. In some embodiments, each core has a network of distributed LDOs to provide efficient control for power management. The LDOs can be digital, analog, or a combination of digital or analog LDOs.

In some embodiments, device 2400 comprises one or more clock generator circuitries, generally referred to as clock generator 2416. Clock generator 2416 generates clock signals at appropriate frequency levels, which may be supplied to any appropriate components of device 2400. Merely as an example, clock generator 2416 is illustrated to be supplying clock signals to processor 2404 of device 2400. In some embodiments, clock generator 2416 receives one or more Frequency Identification (FID) signals, and generates the clock signals at an appropriate frequency, based on the FID signals.

In some embodiments, device 2400 comprises battery 2418 supplying power to various components of device 2400. Merely as an example, battery 2418 is illustrated to be supplying power to processor 2404. Although not illustrated in the figures, device 2400 may comprise a charging circuitry, e.g., to recharge the battery, based on Alternating Current (AC) power supply received from an AC adapter. In some embodiments, battery 2418 includes logic for inference based fast charging.

In some embodiments, device 2400 comprises Power Control Unit (PCU) 2410 (also referred to as Power Management Unit (PMU), Power Controller, etc.). In an example, some sections of PCU 2410 may be implemented by one or more processing cores 2408, and these sections of PCU 2410 are symbolically illustrated using a dotted box and labelled PCU 2410a. In an example, some other sections of PCU 2410 may be implemented outside the processing cores 2408, and these sections of PCU 2410 are symbolically illustrated using a dotted box and labelled as PCU 2410b. PCU 2410 may implement various power management operations for device 2400. PCU 2410 may include hardware interfaces, hardware circuitries, connectors, registers, etc., as well as software components (e.g., drivers, protocol stacks), to implement various power management operations for device 2400. In some embodiments, PMU 4410 includes logic for inference based fast charging.

In some embodiments, device 2400 comprises Power Management Integrated Circuit (PMIC) 2412, e.g., to implement various power management operations for device 2400. In some embodiments, PMIC 2412 is a Reconfigurable Power Management ICs (RPMICs) and/or an IMVP (Intel® Mobile Voltage Positioning). In an example, the PMIC is within an IC chip separate from processor 2404. The may implement various power management operations for device 2400. PMIC 2412 may include hardware interfaces, hardware circuitries, connectors, registers, etc., as well as software components (e.g., drivers, protocol stacks), to implement various power management operations for device 2400. In some embodiments, PMIC 2412 includes logic for inference based fast charging.

In an example, device 2400 comprises one or both PCU 2410 or PMIC 2412. In an example, any one of PCU 2410 or PMIC 2412 may be absent in device 2400, and hence, these components are illustrated using dotted lines.

Various power management operations of device 2400 may be performed by PCU 2410, by PMIC 2412, or by a combination of PCU 2410 and PMIC 2412. For example, PCU 2410 and/or PMIC 2412 may select a power state (e.g., P-state) for various components of device 2400. For example, PCU 2410 and/or PMIC 2412 may select a power state (e.g., in accordance with the ACPI (Advanced Configuration and Power Interface) specification) for various components of device 2400. Merely as an example, PCU 2410 and/or PMIC 2412 may cause various components of the device 2400 to transition to a sleep state, to an active state, to an appropriate C state (e.g., CO state, or another appropriate C state, in accordance with the ACPI specification), etc. In an example, PCU 2410 and/or PMIC 2412 may control a voltage output by VR 2414 and/or a frequency of a clock signal output by the clock generator, e.g., by outputting the VID signal and/or the FID signal, respectively. In an example, PCU 2410 and/or PMIC 2412 may control battery power usage, charging of battery 2418, and features related to power saving operation.

The clock generator 2416 can comprise a phase locked loop (PLL), frequency locked loop (FLL), or any suitable clock source. In some embodiments, each core of processor 2404 has its own clock source. As such, each core can operate at a frequency independent of the frequency of operation of the other core. In some embodiments, PCU 2410 and/or PMIC 2412 performs adaptive or dynamic frequency scaling or adjustment. For example, clock frequency of a processor core can be increased if the core is not operating at its maximum power consumption threshold or limit. In some embodiments, PCU 2410 and/or PMIC 2412 determines the operating condition of each core of a processor, and opportunistically adjusts frequency and/or power supply voltage of that core without the core clocking source (e.g., PLL of that core) losing lock when the PCU 2410 and/or PMIC 2412 determines that the core is operating below a target performance level. For example, if a core is drawing current from a power supply rail less than a total current allocated for that core or processor 2404, then PCU 2410 and/or PMIC 2412 can temporality increase the power draw for that core or processor 2404 (e.g., by increasing clock frequency and/or power supply voltage level) so that the core or processor 2404 can perform at higher performance level. As such, voltage and/or frequency can be increased temporality for processor 2404 without violating product reliability.

In an example, PCU 2410 and/or PMIC 2412 may perform power management operations, e.g., based at least in part on receiving measurements from power measurement circuitries 2442, temperature measurement circuitries 2440, charge level of battery 2418, and/or any other appropriate information that may be used for power management. To that end, PMIC 2412 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 2410 and/or PMIC 2412 in at least one embodiment to allow PCU 2410 and/or PMIC 2412 to manage processor core energy at least in part based on value(s) detected by one or more of the sensors.

Also illustrated is an example software stack of device 2400 (although not all elements of the software stack are illustrated). Merely as an example, processors 2404 may execute application programs 2450, Operating System 2452, one or more Power Management (PM) specific application programs (e.g., generically referred to as PM applications 2458), and/or the like. PM applications 2458 may also be executed by the PCU 2410 and/or PMIC 2412. OS 2452 may also include one or more PM applications 2456a, 2456b, 2456c. The OS 2452 may also include various drivers 2454a, 2454b, 2454c, etc., some of which may be specific for power management purposes. In some embodiments, device 2400 may further comprise a Basic Input/Output System (BIOS) 2420. BIOS 2420 may communicate with OS 2452 (e.g., via one or more drivers 2454), communicate with processors 2404, etc.

For example, one or more of PM applications 2458, 2456, drivers 2454, BIOS 2420, etc. may be used to implement power management specific tasks, e.g., to control voltage and/or frequency of various components of device 2400, to control wake-up state, sleep state, and/or any other appropriate power state of various components of device 2400, control battery power usage, charging of the battery 2418, features related to power saving operation, etc.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

Various embodiments described herein are illustrated as examples. The features of these examples can be combined with one another in any suitable way. These examples include:

Example 1: A machine-readable storage media having machine-executable instructions that when executed, cause one or more processors to perform a method comprising: checking charge level and/or voltage of a battery against a threshold to determine whether the battery is eligible for fast charging; monitoring current usage behavior and/or context of a device powered by the battery; determining whether the battery is to be fast charged based on the monitored current usage behavior and/or context of the device; determining whether a charger can support the device and fast charge the battery concurrently; and fast charging the battery if it is determined that the charger can support the device and fast charge the battery concurrently.

Example 2: The machine-readable storage media of example 1, having machine-executable instructions that when executed, cause one or more processors to perform the method comprising: modifying one or more system parameters if it is determined that the charger cannot support the device and fast charge the battery concurrently; and fast charging the battery in response to modifying one or more parameters.

Example 3: The machine-readable storage media of example 2, having machine-executable instructions that when executed, cause one or more processors to perform the method comprising: prior to modifying, requesting permission from a user to modify the one or more parameters.

Example 4: The machine-readable storage media of example 2, having machine-executable instructions that when executed, cause one or more processors to perform the method comprising: prior to modifying, providing a selection menu comprising the one or more system parameters for a user to select.

Example 5: The machine-readable storage media of example 2, wherein the one or more parameters include: connection of Wi-Fi radio to an access point; execution of a background application; display intensity; operating clock frequency, enabling or disabling one or more sensors, and automatic downloading of emails and/or attachments.

Example 6: The machine-readable storage media of example 1, having machine-executable instructions that when executed, cause one or more processors to perform the method comprising: requesting permission from a user to start fast charging of the battery.

Example 7: The machine-readable storage media of example 1, wherein the current usage behavior and/or context of the device includes one or more of: location of the device, schedule of the device, application executing by the device, user preference inferred by machine-learning, user permission to execute one or more applications as inferred by machine-learning, and/or application displayed on a screen of the device.

Example 8: The machine-readable storage media of example 1, having machine-executable instructions that when executed, cause one or more processors to perform the method comprising: performing normal charging of the battery if it is determined that the battery is not eligible for fast charging.

Example 9: The machine-readable storage media of example 1, wherein fast charging is greater or equal to 0.5 C, and wherein normal charging is less than 0.5 C.

Example 10: The machine-readable storage media of example 1, wherein fast charging the battery comprises automatic fast charging before a scheduled power outage.

Example 11: The machine-readable storage media of example 1, wherein fast charging the battery comprises automatic fast charging before sensing an imminent natural event including: earthquake, tornado, flood, and thunderstorm.

Example 12: The machine-readable storage media of example 1, wherein the monitored current usage behavior and/or context of the device includes time duration to a situation and/or time duration of the situation.

Example 13: The machine-readable storage media of example 12, having machine-executable instructions that when executed, cause one or more processors to perform the method comprising: calculating a required charge level of the battery for the situation; calculating a charge possible for the battery for the time duration; comparing the calculated required charge level and the charge possible; determining if fast charging is needed based on the comparing, and determining a charge profile based on the calculating of the required charge level and the possible charge for the battery.

Example 14: A battery powered apparatus comprising: a battery; an interface to charge the battery; a display to be powered by the battery; and a processor to be powered by the battery, wherein the processor is to: check charge level and/or voltage of the battery against a threshold to determine whether the battery is eligible for fast charging; monitor current usage behavior and/or context of the battery powered apparatus; determine whether the battery is to be fast charged based on the monitored current usage behavior and/or context of the apparatus; determine whether a charger can support the apparatus and fast charge the battery concurrently; and fast charge the battery through the interface if it is determined that the charger can support the apparatus and fast charge the battery concurrently.

Example 15: The battery powered apparatus of example 14, wherein the processor is to: modify one or more system parameters if it is determined that the charger cannot support the apparatus and fast charge the battery concurrently; and fast charge the battery in response to modifying one or more parameters.

Example 16: The battery powered apparatus of example 15, wherein the processor, prior to modification of the one or more system parameters, is to request permission from a user to modify the one or more system parameters.

Example 17: The battery powered apparatus of example 15, wherein the processor, prior to modification of the one or more system parameters, is to provide a selection menu comprising the one or more system parameters for a user to select.

Example 18: The battery powered apparatus of example 15, wherein: the one or more parameters include: connection of Wi-Fi radio to an access point; execution of a background application; display intensity; operating clock frequency, enabling or disabling one or more sensors, and automatic downloading of emails and/or attachments; the current usage behavior and/or context of the apparatus includes one or more of: location of the apparatus, schedule of the apparatus, application executing by the apparatus, and/or application displayed on the display of the apparatus; fast charge is greater or equal to 0.5 C; and normal charge is less than 0.5 C.

Example 19: The battery powered apparatus of example 15, wherein the processor is to: request permission from a user to start fast charging of the battery; and fast charge the battery automatically before a scheduled power outage; or fast charge before an imminent natural event is sensed, including: earthquake, tornado, flood, and thunderstorm; and perform normal charging of the battery if it is determined that the battery is not eligible for fast charge.

Example 20: A system comprising: a battery unit comprising a battery cell and a microcontroller; a charger coupled to the batter unit; a processor powered by the battery unit; and a display coupled to the processor and powered by the battery unit, wherein the microcontroller is to: check charge level and/or voltage of the battery cell against a threshold to determine whether the battery cell is eligible for fast charging; monitor current usage behavior and/or context of the system; determine whether the battery cell is to be fast charged based on the monitored current usage behavior and/or context of the system; determine whether the charger can support the system and fast charge the battery cell concurrently; and fast charge the battery cell via the charger if it is determined that the charger can support the system and fast charge the battery cell concurrently.

Example 21: The system of example 20, wherein: the current usage behavior and/or context of the system includes one or more of: location of the system, schedule of the system, application executing by the processor, and/or application displayed on the display of the system; fast charge is greater or equal to 0.5 C; and normal charge is less than 0.5 C.

Example 22: The system of example 20, wherein the microcontroller is to: request permission from a user to start fast charging of the battery cell; and fast charge the battery cell automatically before a scheduled power outage; or fast charge before an imminent natural event is sensed, including: earthquake, tornado, flood, and thunderstorm; and perform normal charging of the battery cell if it is determined that the battery cell is not eligible for fast charge.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. A machine-readable storage media having machine-executable instructions that when executed, cause one or more processors to perform a method comprising:
checking charge level and/or voltage of a battery against a threshold to determine whether the battery is eligible for fast charging;
monitoring current usage behavior and/or context of a device powered by the battery;
determining whether the battery is to be fast charged based on the monitored current usage behavior and/or context of the device;
determining whether a charger can support the device and fast charge the battery concurrently; and
fast charging the battery if it is determined that the charger can support the device and fast charge the battery concurrently.

2. The machine-readable storage media of claim 1, having machine-executable instructions that when executed, cause one or more processors to perform the method comprising:
modifying one or more system parameters if it is determined that the charger cannot support the device and fast charge the battery concurrently; and
fast charging the battery in response to modifying one or more parameters.

3. The machine-readable storage media of claim 2, having machine-executable instructions that when executed, cause one or more processors to perform the method comprising:
prior to modifying, requesting permission from a user to modify the one or more parameters.

4. The machine-readable storage media of claim 2, having machine-executable instructions that when executed, cause one or more processors to perform the method comprising:
prior to modifying, providing a selection menu comprising the one or more parameters for a user to select.

5. The machine-readable storage media of claim 2, wherein the one or more parameters include: connection of Wi-Fi radio to an access point; execution of a background application; display intensity; operating clock frequency, enabling or disabling one or more sensors, and automatic downloading of emails and/or attachments.

6. The machine-readable storage media of claim 1, having machine-executable instructions that when executed, cause one or more processors to perform the method comprising:
requesting permission from a user to start fast charging of the battery.

7. The machine-readable storage media of claim 1, wherein the current usage behavior and/or context of the device includes one or more of: location of the device, schedule of the device, application executing by the device, user preference inferred by machine-learning, user permission to execute one or more applications as inferred by machine-learning, and/or application displayed on a screen of the device.

8. The machine-readable storage media of claim 1, having machine-executable instructions that when executed, cause one or more processors to perform the method comprising:
performing normal charging of the battery if it is determined that the battery is not eligible for fast charging.

9. The machine-readable storage media of claim 1, wherein fast charging is greater or equal to 0.5 C, and wherein normal charging is less than 0.5 C.

10. The machine-readable storage media of claim 1, wherein fast charging the battery comprises automatic fast charging before a scheduled power outage.

11. The machine-readable storage media of claim 1, wherein fast charging the battery comprises automatic fast charging before sensing an imminent natural event including: earthquake, tornado, flood, and thunderstorm.

12. The machine-readable storage media of claim 1, wherein the monitored current usage behavior and/or context of the device includes time duration to a situation and/or time duration of the situation.

13. The machine-readable storage media of claim 12, having machine-executable instructions that when executed, cause one or more processors to perform the method comprising:
calculating a required charge level of the battery for the situation;
calculating a possible charge for the battery for the time duration;
comparing the calculated required charge level and the possible charge;
determining if fast charging is needed based on the comparing; and
determining a charge profile based on the calculating of the required charge level and the possible charge for the battery.

14. A battery powered apparatus comprising:
a battery;
an interface to charge the battery;
a display to be powered by the battery; and
a processor to be powered by the battery, wherein the processor is to:
check charge level and/or voltage of the battery against a threshold to determine whether the battery is eligible for fast charging;
monitor current usage behavior and/or context of the battery powered apparatus;
determine whether the battery is to be fast charged based on the monitored current usage behavior and/or context of the apparatus;
determine whether a charger can support the apparatus and fast charge the battery concurrently; and
fast charge the battery through the interface if it is determined that the charger can support the apparatus and fast charge the battery concurrently.

15. The battery powered apparatus of claim 14, wherein the processor is to:
modify one or more system parameters if it is determined that the charger cannot support the apparatus and fast charge the battery concurrently; and
fast charge the battery in response to modifying one or more parameters.

16. The battery powered apparatus of claim 15, wherein the processor,
prior to modification of the one or more system parameters, is to request permission from a user to modify the one or more system parameters.

17. The battery powered apparatus of claim 15, wherein the processor,
prior to modification of the one or more system parameters, is to provide a selection menu comprising the one or more system parameters for a user to select.

18. The battery powered apparatus of claim 15, wherein:
the one or more parameters include: connection of Wi-Fi radio to an access point; execution of a background application; display intensity; operating clock frequency, enabling or disabling one or more sensors, and automatic downloading of emails and/or attachments;
the current usage behavior and/or context of the apparatus includes one or more of: location of the apparatus, schedule of the apparatus, application executing by the apparatus, and/or application displayed on the display of the apparatus;
fast charge is greater or equal to 0.5 C; and
normal charge is less than 0.5 C.

19. The battery powered apparatus of claim 15, wherein the processor is to:
request permission from a user to start fast charging of the battery; and
fast charge the battery automatically before a scheduled power outage; or
fast charge before an imminent natural event is sensed, including: earthquake, tornado, flood, and thunderstorm; and
perform normal charging of the battery if it is determined that the battery is not eligible for fast charge.

20. A system comprising:
a battery unit comprising a battery cell and a microcontroller;
a charger coupled to the batter unit;
a processor powered by the battery unit; and
a display coupled to the processor and powered by the battery unit, wherein the microcontroller is to:
check charge level and/or voltage of the battery cell against a threshold to determine whether the battery cell is eligible for fast charging;
monitor current usage behavior and/or context of the system;
determine whether the battery cell is to be fast charged based on the monitored current usage behavior and/or context of the system;
determine whether the charger can support the system and fast charge the battery cell concurrently; and
fast charge the battery cell via the charger if it is determined that the charger can support the system and fast charge the battery cell concurrently.

21. The system of claim 20, wherein:
The current usage behavior and/or context of the system includes one or more of: location of the system, schedule of the system, application executing by the processor, and/or application displayed on the display of the system;
fast charge is greater or equal to 0.5 C; and
normal charge is less than 0.5 C.

22. The system of claim 20, wherein the microcontroller is to:
request permission from a user to start fast charging of the battery cell; and
fast charge the battery cell automatically before a scheduled power outage; or
fast charge before an imminent natural event is sensed, including: earthquake, tornado, flood, and thunderstorm; and
perform normal charging of the battery cell if it is determined that the battery cell is not eligible for fast charge.
